(19) United States
(12) Patent Application Publication
(10) Pub. No.: US 2026/0200490 A1
(43) Pub. Date: Jul. 16, 2026

(54) VEHICLE CONTROL METHOD AND APPARATUS

(71) Applicant: CARIAD (CHINA) CO., LTD., Beijing (CN)

(72) Inventors: Zhimin GU, Beijing (CN); Jie SHI, Beijing (CN)

(21) Appl. No.: 19/444,049

(22) Filed: Jan. 8, 2026

(30) Foreign Application Priority Data
Jan. 13, 2025 (CN) 202510049872.5

(51) Int. Cl. B60W 50/14; G06V 20/58

(52) U.S. Cl. CPC B60W 50/14; G06V 20/58; B60W 2420/403; B60W 2540/215; B60W 2554/802

(57) ABSTRACT

The present invention provides a vehicle control method and a vehicle control apparatus that, in response to a sensitive mode set by a user, determines at least one sensitive condition corresponding to the sensitive mode; recognizes surrounding environment of a vehicle and determines that the surrounding environment concurrently satisfies the at least one sensitive condition, based on the at least one sensitive condition; and performs a processing strategy corresponding to the sensitive mode.

### CROSS-REFERENCE TO RELATED APPLICATION(S)

This application claims priority to Chinese Application No. 202510049872.5 filed January 13, 2025, the disclosure of which is incorporated herein by reference in its entirety.

### FIELD

The present invention relates to the field of vehicle control, and specifically to a vehicle control method and a vehicle control apparatus.

### BACKGROUND

As the vehicle industry develops constantly and people’s living standard improves increasingly, vehicles are prevailingly used in people’s daily life. A level of intelligent vehicle control has gradually become a focus of attention for drivers and passengers. In related technologies, a warning system typically equipped with a sentry mode are used to record an observation video for a user that can be activated later, or to alarm the user when events such as scratch or crash occur.

Therefore, it is urgently necessary to provide a vehicle control method and a vehicle control apparatus which can satisfy the personalized demands of the user, thereby overcoming the above problem.

It should be noted that the information disclosed in the Background is only used to enhance understanding of the present invention, and therefore it might contain information that does not constitute the prior art already known by those skilled in the art.

### SUMMARY

In order to solve the problems existing in the prior art, the present invention provides a vehicle control method and a vehicle control apparatus.

The present invention provides a vehicle control method, including:

in response to a sensitive mode set by a user, determining at least one sensitive condition corresponding to the sensitive mode;

recognizing a surrounding environment of a vehicle and determining that the surrounding environment concurrently satisfies the at least one sensitive condition, based on the at least one sensitive condition; and

performing a processing strategy corresponding to the sensitive mode.

According to an embodiment of the present invention, recognizing the surrounding environment of a vehicle and determining that the surrounding environment concurrently satisfies the at least one sensitive condition, based on the at least one sensitive condition includes:

for any of the at least one sensitive condition, obtaining a type of the environment information corresponding to the sensitive condition and a recognition strategy corresponding to the sensitive condition; and

obtaining information about the surrounding environment based on the type of the environment information, performing condition recognition on the information about the surrounding environment based on the recognition strategy, and determining that the surrounding environment satisfies the at least one sensitive condition.

According to an embodiment of the present invention, the type of the environment information includes image information, the recognition strategy includes performing image recognition on the image information.

According to an embodiment of the present invention, the sensitive condition includes a pedestrian category, and obtaining information about the surrounding environment based on the type of the environment information, performing condition recognition on the information about the surrounding environment based on the recognition strategy, and determining that the surrounding environment satisfies the at least one sensitive condition, includes:

obtaining a pedestrian image of at least one pedestrian around the vehicle;

performing category recognition on the pedestrian based on the pedestrian image; and

in response to the category of the pedestrian being a target category, determining that the pedestrian satisfies the sensitive condition.

According to an embodiment of the present invention, performing category recognition on the pedestrian based on the pedestrian image includes:

obtaining a target feature corresponding to the target category; and

determining whether the pedestrian image includes the target feature; wherein, in response to the pedestrian image including the target feature, the category of the pedestrian is determined as the target category, and in response to the pedestrian image not including the target feature, the category of the pedestrian is not determined as the target category.

According to an embodiment of the present invention, the target feature includes a dressing feature, the method further including:

inputting the pedestrian image into a feature extraction model, and extracting the dressing feature of the pedestrian;

determining whether the dressing feature of the pedestrian matches the target feature corresponding to the target category; and

in response to the dressing feature of the pedestrian matching the target feature corresponding to the target category, determining that the pedestrian is the target category.

According to an embodiment of the present invention, the sensitive condition further includes a sensitive distance, the method further including:

in response to the category of the pedestrian being the target category, determining whether that a distance between the pedestrian and the vehicle is less than or equal to the sensitive distance based on the pedestrian image; and

in response to the distance between the pedestrian and the vehicle being less than or equal to the sensitive distance, determining that the pedestrian satisfies the sensitive condition.

According to an embodiment of the present invention, the target category and the sensitive distance have a one-to-one correspondence.

According to an embodiment of the present invention, the type of the environment information includes sensing information, and the recognition strategy includes performing data recognition on the sensing information.

According to an embodiment of the present invention, the sensitive condition includes vibration information, and obtaining information about the surrounding environment based on the type of the environment information, performing condition recognition on the information about the surrounding environment based on the recognition strategy, and determining that the surrounding environment satisfies the at least one sensitive condition, includes:

obtaining a vibration signal generated by a vehicle body through a vibration sensor, and determining a category and an amplitude of the vibration signal; and

in response to the vibration signal being a target signal and the amplitude of the vibration signal being greater than or equal to a sensitive amplitude, determining that the vibration signal is satisfies the sensitive condition.

According to an embodiment of the present invention, determining at least one sensitive condition corresponding to the sensitive mode in response to a sensitive mode set by a user, includes:

in response to an action of the user selecting the sensitive mode, determining that the user set the corresponding sensitive mode, and determining the at least one sensitive condition corresponding to the sensitive mode.

According to an embodiment of the present invention, performing a processing strategy corresponding to the sensitive mode includes:

sending first alarm information to a driver and/or triggering local transmission of second alarm information.

According to another aspect of the present invention, there is further provided a vehicle control apparatus, including:

a response module, configured to, in response to a sensitive mode set by a user, determine at least one sensitive condition corresponding to the sensitive mode;

a recognition module, configured to recognize surrounding environment of a vehicle and determine that the surrounding environment concurrently satisfies the at least one sensitive condition, based on the at least one sensitive condition; and

an alarm module, configured to perform a processing strategy corresponding to the sensitive mode.

According to a further aspect of the present invention, there is further provided a computer device, including: a memory, a processor, and a computer program stored on the memory and executable on the processor which, when executed by the processor, implements the steps of the vehicle control method described above.

According to a further aspect of the present invention, there is further provided a computer-readable storage medium having a computer program stored thereon which, when executed by a processor, implements the steps of the vehicle control method described above.

According to a further aspect of the present invention, there is further provided a computer program product comprising computer instructions which, when executed by a processor, implements the steps of the vehicle control method described above.

Through the vehicle control method provided in the embodiments of the present application, in response to the sensitive mode set by the user and at least one sensitive condition corresponding to the sensitive mode, the surrounding environment of the vehicle can be recognized, and when the surrounding environment concurrently satisfies the at least one sensitive condition, the processing strategy corresponding to the sensitive mode is performed.

### BRIEF DESCRIPTION OF THE DRAWINGS

The above and other features of the present invention will be described in detail hereinafter with reference to specific exemplary embodiments which are illustrated in the accompanying drawings. The exemplary embodiments are given by way of illustration only, and thus are not intended to limit the present invention. Among the figures,

FIG. 1 illustrates an exemplary system architecture adapted for a specific embodiment of a vehicle control method according to the present invention.

FIG. 2 illustrates a flowchart of a vehicle control method according to an embodiment of the present invention.

FIG. 3 illustrates a flowchart of a vehicle control method according to another embodiment of the present invention.

FIG. 4 illustrates a flowchart of a vehicle control method according to a further embodiment of the present invention.

FIG. 5 illustrates a flowchart of a vehicle control method according to yet another embodiment of the present invention.

FIG. 6 illustrates a schematic structural diagram of a vehicle control apparatus according to an embodiment of the present invention.

### DETAILED DESCRIPTION OF EMBODIMENTS

The present invention will be described below in detail by describing specific embodiments, to enable those having ordinary skill in the art to easily implement the present invention according to the content disclosed in the description. The embodiments described below are only partial embodiments rather than all embodiments of the present invention. Based on the embodiment described in the description, all other embodiments obtained by those having ordinary skills in the art without making inventive efforts fall within the scope of protection of the present invention. It should be noted that the embodiments and features in the embodiments described in the description may be combined with each other in a case that no conflicts occur.

The technical terms used in the text herein are only intended to illustrate specific embodiments and not intended to limit the present invention. Unless the context clearly indicates otherwise, singular forms “one”, “an” and “the” used herein also include plural forms “a plurality of”, “multiple” and “these”. As used herein, the terms such as “first” and “second” are only used to distinguish different features, steps, operations, elements and/or members etc., do not represent any specific technical meaning, nor do they represent a necessary logic order therebetween. The term “a plurality of” used in the text herein may refer to two or more, and the term “at least one” may refer to one, two or more. Any feature, step, operation, element and/or member mentioned herein may generally be understood as one or more, unless the context clearly indicates otherwise. It should be understood that terms “include/including” and/or “comprise/comprising” used herein refer to that there exists the feature, step, operation, element and/or member, and do not exclude the existence or addition of one or more other features, steps, operations, elements, members and/or combinations thereof. The term “and/or” used herein comprises any or all combinations of one or more relevant listed objects. Element suffixes “modules” and “units” herein are used only for ease of description, so they can be used interchangeably and do not have any distinguishing senses or functions.

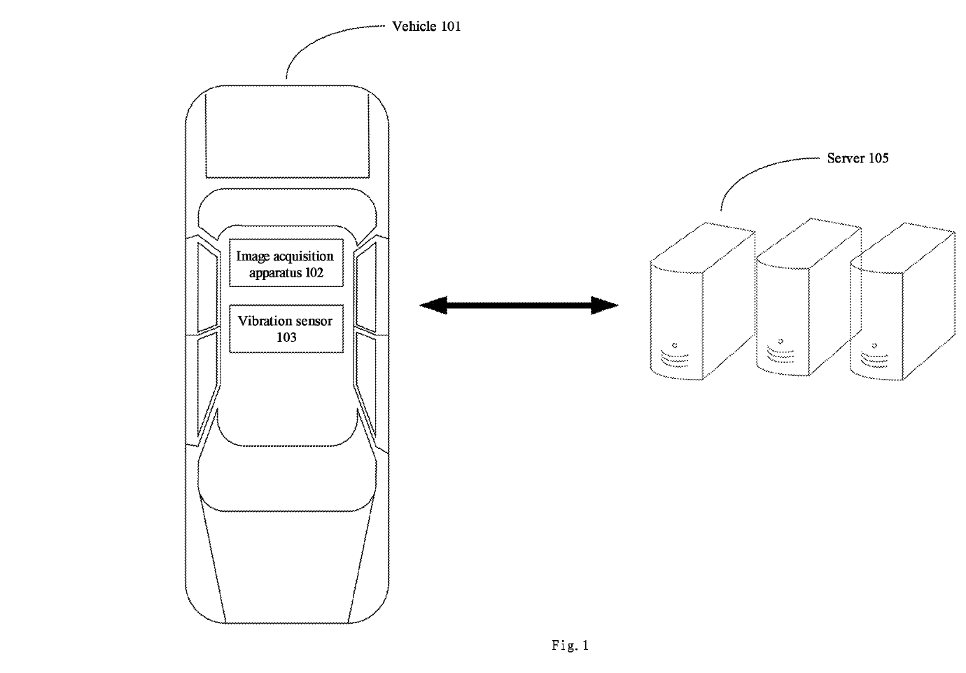

As personalized demands of the driver increase, the existing sentry mode struggles to satisfy the personalized demands of the user. As schematically illustrated in FIG. 1, an exemplary system architecture 100 adapted for one specific embodiment of a vehicle control method according to the present invention is illustrated. The system architecture 100 may include a vehicle 101, an image acquisition device 102, a vibration sensor 103, and a server 104.

The image acquisition device 102 is configured to acquire image information in surrounding environment of the vehicle 101. The image acquisition device 102 may be disposed on the top of the vehicle or may be disposed around the vehicle. When the image acquisition device 102 is disposed on the top of the vehicle, the image acquisition device 102 may be a panoramic camera for acquiring environmental images around the vehicle; when the image acquisition device 102 is disposed around the vehicle, a plurality of environmental images captured by a plurality of the image acquisition devices 102 are stitched by an image stitching technique to acquire the environmental images around the vehicle.

The vibration sensor 103 is configured to detect a vibration signal of the vehicle 101, and may be disposed around the vehicle to collect the vibration signals around a body of the vehicle 101.

The server 104 is connected to the image acquisition device 102, and the vibration sensor 103, respectively; and the server 104 is configured to in response to a sensitivity level set by the user, determine at least one sensitive condition corresponding to the sensitivity level; based on the at least one sensitive condition, receive the environmental images captured by the image acquisition devices 102 and the vibration signals collected by the vibration sensor 103; and, when analysis shows that the environmental images and/or the vibration signals satisfy the at least one sensitive condition corresponding to the sensitivity level, control the vehicle to perform a processing strategy corresponding to the sensitivity level, so as to achieve the purpose of personalized setting of the vehicle control by the drivers and passengers.

Optionally, the server 104 may be an independent physical server, may be a server cluster or a distributed system composed of a plurality of physical servers, and may also be a cloud server providing a basic cloud computing service such as a cloud service, a cloud database, cloud computing, a cloud function, a cloud storage, a network service, cloud communication, a middleware service, a domain service, a security service, CDN, big data and an artificial intelligence platform.

The image acquisition device 102, and the vibration sensor 103 are directly or indirectly connected to the server 104 in a wireless communication manner. Optionally, the wireless network described above uses a standard communication technique and/or protocol. The network is typically the Internet, but may also be any network including, but not limited to, a Local Area Network (LAN), a Metropolitan Area Network (MAN), a Wide Area Network (WAN), a mobile network, a wired network or wireless network, a private network, or a virtual private network, or any combinations thereof.

It should be noted that the vehicle control method provided in the embodiment of the present application may be executed by a vehicle-mounted terminal, or by the server 104, or by the vehicle-mounted terminal in cooperation with the server 104. Accordingly, a vehicle control apparatus may be disposed in the vehicle-mounted terminal, in the server 104, or in both the vehicle-mounted terminal and the server 104.

It should be understood that the above-described system architecture 100 may not include the server 104 when the vehicle control method provided by the embodiment of the present application is executed by the vehicle-mounted terminal.

It should be understood that a number and type of the image acquisition device 102, and the vibration sensor 103 in FIG. 1 are merely illustrative. In a specific implementation, there may be any number and types of image acquisition devices 102, the vibration sensors 103 and servers 104, as actually needed.

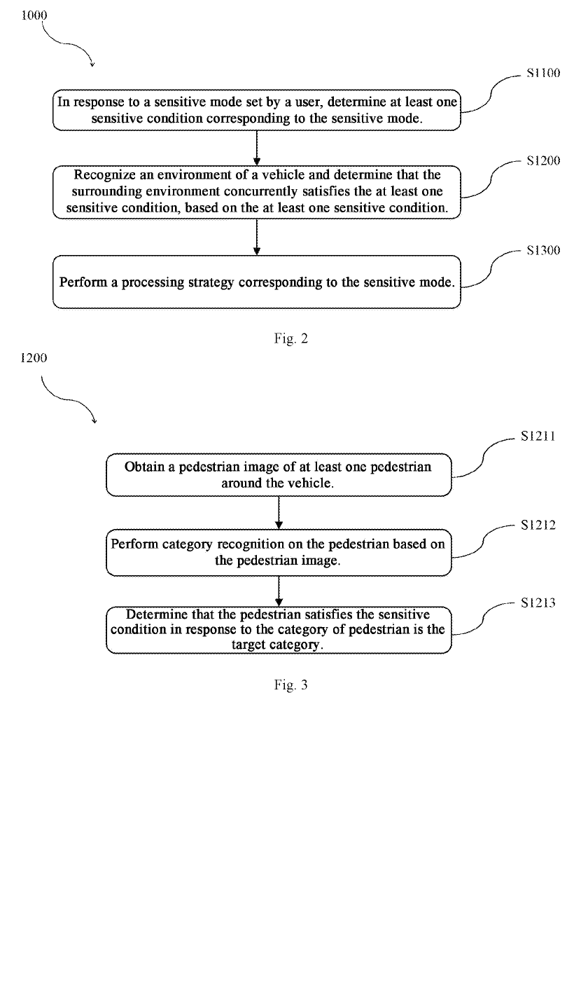

As shown in FIG. 2, the present invention provides a vehicle control method 1000. Specifically, the method 1000 includes:

S1100, in response to a sensitive mode set by a user, at least one sensitive condition corresponding to the sensitive mode is determined.

S1200, an environment of a vehicle is recognized and it is determined that the surrounding environment concurrently satisfies the at least one sensitive condition, based on the at least one sensitive condition.

S1300, a processing strategy corresponding to the sensitive mode is performed.

It should be noted that the sensitive mode is an operation mode for performing detection, recognition, and alarming on the vehicle, and includes at least one sensitive condition and alarm manner; the sensitive condition includes an attribute and a threshold corresponding thereto. For example, the sensitive condition is vibration information and a threshold corresponding thereto, or a distance and a magnitude thereof.

In an embodiment, the user may set personalized sensitive modes through an interactive interface.

For instance, the interactive interface may provide the user with prompt information for at least one sensitive attribute, the user selects an attribute requiring sensitive detection and set a threshold corresponding to the sensitive attribute. As an example, the user may select “vibration information” as an attribute of the sensitive condition, and then set “vibration amplitude” as the threshold of the sensitive condition; may also select “distance” as the attribute of the sensitive condition, and then set “distance magnitude” as the threshold of the sensitive condition.

Preferably, users may set one or more sensitive conditions, and one or more conditions may be triggered independently or jointly.

For instance, when the vibration signal is the sensitive condition, it can be triggered independently, i.e., when the vibration signal satisfies the condition, the processing strategy corresponding to the sensitive condition is triggered; when the distance is the sensitive condition, it must be combined with other sensitive conditions for joint triggering, for example, both a distance condition and a pedestrian category condition are satisfied concurrently, which equivalent to triggering the processing strategy of the sensitive mode when a specific pedestrian is detected within a certain distance from the vehicle.

In an embodiment, a corresponding recognition and determination may be performed separately for each sensitive condition. Specifically, for any one of the sensitive conditions, a type of the environment information corresponding to the one sensitive condition and a recognition strategy corresponding to the one sensitive condition are obtained, and information about the surrounding environment is obtained based on the type of the environment information, condition recognition is performed on the information about the surrounding environment based on the recognition strategy to determine that the surrounding environment satisfies the sensitive condition.

Optionally, the type of the environment information includes image information and sensor information, the recognition strategy includes performing pattern recognition on the image information and data recognition on the sensing information.

Therefore, in the vehicle control method provided in the embodiments of the present application, in response to the sensitive mode set by the user and at least one sensitive condition corresponding to the sensitive mode, the surrounding environment of the vehicle can be recognized, and when the surrounding environment concurrently satisfies the at least one sensitive condition, the processing strategy corresponding to the sensitive mode is performed, so as to achieve a purpose of recognizing the sensitive environment corresponding to personalized setting of the user, thereby satisfying recognition requirements of the user for the surrounding environment and improving user experience.

In one implementation, the sensitive condition is pedestrian category.

As shown in FIG. 3, obtaining information about the ambient environment based on the type of the environment information, performing condition recognition on the information about the surrounding environment based on the recognition strategy, and determining that the surrounding environment satisfies the at least one sensitive condition, includes:

S1211, a pedestrian image of at least one pedestrian around the vehicle is obtained.

It should be noted that, in the embodiments of the present application, an image recognition model can be used for obtaining the pedestrian image.

Specifically, the environmental images acquired by the image acquisition device disposed on the vehicle are input into a first image recognition model, and the first image recognition model performs feature extraction and category recognition on the environmental images, when a recognition result is the pedestrian, the pedestrian image corresponding to the at least one pedestrian in the environmental images is acquired through a labeling or an image segmentation technique.

S1212, category recognition on the pedestrian is performed based on the pedestrian image.

It should be noted that the performing category recognition on the pedestrian includes determining whether the pedestrian belongs to a target category. The target category may be a category set by the user when setting the sensitive mode, such as a danger category, or may be a target feature set by the user when setting the sensitive mode, such as facial occlusion.

In an embodiment, when the target category is the danger category, the pedestrian image can be recognized according to features corresponding to the preset danger category, in response to the pedestrian in the pedestrian image satisfying the features corresponding to the danger category, the pedestrian is considered to be the target category, in response to the pedestrian in the pedestrian image not satisfying the features corresponding to the danger category, the pedestrian is considered not to be the target category.

In an embodiment, the target feature corresponding to the target category is obtained, and whether the pedestrian image includes the target feature is determined, in response to the pedestrian image including the target feature, a category of the pedestrian is determined to be the target category, in response to the pedestrian image not including the target feature, the category of the pedestrian is determined not to be the target category.

That is, when the target category is the target feature, the pedestrian image is input into a feature extraction model to extract a dressing feature of the pedestrian, i.e., an output of the feature extraction model is dressing information about the pedestrian, such as colors and styles of clothing, pants, shoes, accessories and the like. In an embodiment, the feature extraction model may also be a second image recognition model configured to recognize features of clothing information, such as clothing, pants, shoes, accessories, from the pedestrian image, and then classify the clothing features to obtain the dressing features of the pedestrian.

After receiving the dressing features of the pedestrian, the dressing features is matched with the target feature corresponding to the sensitive mode set by the user, and in response to the dressing features being consistent with the target feature, it indicates that the dressing of the pedestrian satisfies the sensitive condition, in response to the dressing features being inconsistent with the target feature, it indicates that the dressing of the pedestrian does not satisfy the sensitive condition,

Optionally, it may be determined whether the dressing feature is consistent with the target feature through a distance between a feature vector of the dressing feature and a feature vector of the target feature.

Specifically, the feature vector corresponding to the dressing features obtained when performing feature extraction on the pedestrian image is acquired; and when the user sets the sensitive mode, a feature vector of a target dressing is acquired by performing semantic extraction based on descriptions of setting parameters of the sensitive mode, or a reference image matched with the target dressing is first acquired when the user sets the sensitive mode, and then the feature vector of the target feature is acquired by performing feature extraction on the reference image. After acquiring the feature vector of the dressing feature and the feature vector of the target feature, an Euclidean distance between the feature vector of the dressing feature and the feature vector of the target feature is calculated, and in response to the Euclidean distance being smaller than or equal to a preset distance, the pedestrian is determined to be the target category, and in response to the Euclidean distance being greater than the pedestrian, the pedestrian is determined not to be the target category.

For example, assuming that the target feature is facial occlusion when the user set the sensitive mode, and the dressing feature obtained when performing feature extraction on the pedestrian image is also the facial occlusion, the pedestrian is considered to be the target category, the dressing feature is not the facial occlusion, the pedestrian is considered not to be the target category.

S1213, in response to the category of the pedestrian being a target category, it is determined that the pedestrian satisfies the sensitive condition.

It should be understood, the target category of the pedestrian may be configured by the user when setting sensitive modes according to demands of the user, including, but not limited to, vulnerable groups, the elderly, and children, so that the driver can be helped to increase the sensitivity to surrounding pedestrians and reduce the risk of himself/herself and surrounding pedestrians through the vehicle auxiliary device.

Further, in an embodiment, the sensitive condition is a sensitive distance.

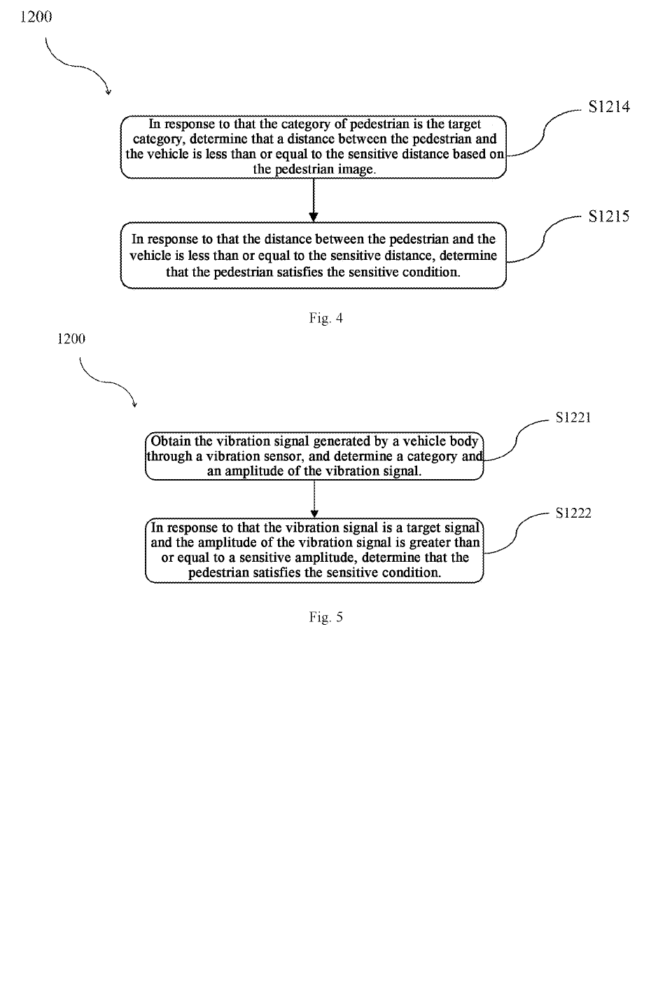

As shown in FIG. 4, the method further includes:

S1214, in response to the category of the pedestrian being the target category, whether a distance between the pedestrian and the vehicle being less than or equal to the sensitive distance is determined based on the pedestrian image.

S1215, in response to the distance between the pedestrian and the vehicle being less than or equal to the sensitive distance, it is determined that the pedestrian satisfies the sensitive condition.

That is, in the embodiments of the present application, a distance determination for sensitive individuals is added, i.e., when the distance between the pedestrian of the target category and the vehicle is less than or equal to the sensitive distance, it is determined that the pedestrian satisfies the sensitive condition. In other words, when the pedestrian of the target category approaches the vehicle, it may pose a danger to the vehicle or the vehicle may pose a danger to the pedestrian, it is determined that the pedestrian satisfies the sensitive condition.

Preferably, the target category corresponds one-to-one with the sensitive distance.

That is, different sensitive distances are set for different categories of pedestrians. As an example, for a pedestrian with a category of the facial occlusion, the user sets a relatively greater sensitive distance when setting the sensitive mode, so as to prompt the driver to pay attention to personal safety in advance; for elderly, children and other categories of pedestrians, the user sets a relatively smaller sensitive distance when setting the sensitive mode, so as to prompt the driver to slow down and drive carefully when such categories of pedestrians approach, thereby avoiding driving danger.

In an embodiment, the sensitive condition is a vibration signal.

As shown in FIG. 5, S1200, obtaining information about the surrounding environment based on the type of the environment information, performing condition recognition on the information about the surrounding environment based on the recognition strategy, and determining that the surrounding environment satisfies the at least one sensitive condition further includes:

S1221, the vibration signal generated by a vehicle body is obtained through a vibration sensor, and a category and an amplitude of the vibration signal are determined.

S1222, in response to the vibration signal being a target signal and the amplitude of the vibration signal being greater than or equal to a sensitive amplitude, it is determined that the pedestrian satisfies the sensitive condition.

It should be noted that, the vibration sensor can detect the vibration signal of the vehicle body, and since there are many reasons for vibration of the vehicle body, such as vehicle bumping, user knocking, scratch, collision, etc. Obviously, the vibrations such as the vehicle bumping and user knocking do not require special attention of the driver, and therefore, the category of the vibration signal is need to be recognized first.

Specifically, through performing cooperative analysis on a plurality of vibration signals collected by a plurality of vibration sensors provided on the vehicle, a vibration signal unique to a specific part on the vehicle body can be obtained, and a vibration source of the vibration signal is from outside the vehicle, and then the vibration signal is determined as the target signal.

As an example, at least one vibration signal collected by at least one vibration sensor provided on the vehicle body is obtained, and an attribute feature of the at least one vibration signal is extracted, such as frequency and amplitude of the vibration signal, and whether the attribute features of the at least one vibration signal are consistent, in response to the attribute features of the at least one vibration signal being consistent, the at least one vibration signal is not the target signal, and in response to the attribute features of at least one vibration signal being inconsistent with the attribute features of other vibration signals, then a vibration source direction of the vibration signal is further determined; in response to the vibration source direction of the vibration signal being inside the vehicle, the vibration signal is considered not to be the target signal, and in response to the vibration source direction of the vibration signal being outside the vehicle, the vibration signal is considered to be the target signal.

In a case that the vibration signal is the target signal, whether the amplitude of the target signal is greater than or equal to the sensitive amplitude is determined, in response to the amplitude of the vibration signal being greater than or equal to the sensitive amplitude, it is determined that the vibration information satisfies the sensitive condition, and in response to the amplitude of the vibration signal being smaller than the sensitive amplitude, it is determined that the vibration information does not satisfy the sensitive condition.

Therefore, the embodiments of the present application can perform sensitivity recognition on the vibration signal applied to the vehicle body from external environment based on the sensitive mode set by the user, so that alarm information is timely issued to the driver when vibration events occur on the vehicle body.

In an embodiment, the user may set corresponding sensitive mode according to actual demands, for example, in relatively dangerous areas, particularly unstable regions, the user may set more target categories for the pedestrians, such as facial occlusion or weapon possession, concurrently, a larger sensitive distance may be set for each target category, i.e., when dangerous people are not yet close, corresponding processing strategies can be made according to the sensitive mode, such as sending alarm information to drivers. Accordingly, in relatively safer areas, fewer target categories may be set, e.g., only elderly, children, etc. and a smaller sensitive distance may be set.

In an embodiment, the sensitive mode may be a plurality of preset sensitive mode, the user determines at least one sensitive condition corresponding to the sensitive mode through selecting from the preset sensitive mode.

Specifically, a high sensitive mode, a medium sensitive mode, and a low sensitive mode may be preset. The high sensitive mode corresponds to a larger number of pedestrian categories and a greater sensitive distance, and is suitable for being applied to the more dangerous areas; the medium sensitive mode corresponds to a certain number of pedestrian categories and a moderate sensitive distance, and is suitable for being applied to conventional urban environments; the low sensitive mode corresponds to a smaller number of pedestrian categories and a smaller sensitive distance, and is suitable for being applied to environments with relatively single environment, such as highways or uninhabited areas.

In response to an action of user selecting the sensitive mode, it is determined that the user set the corresponding sensitive mode, the at least one sensitive condition corresponding to the sensitive mode is further obtained, and based on the at least one sensitive condition, the surrounding environment of the vehicle is recognized, and when the surrounding environment concurrently satisfies the at least one sensitive condition, based on the at least one sensitive condition, the processing strategy corresponding to the sensitive mode is performed.

In an embodiment, performing a processing strategy corresponding to the sensitive mode includes: sending first alarm information to a driver and/or triggering local transmission of second alarm information.

The first alarm information is alarm information sent to the driver through the server, including, but not limited to, images, text prompts, preset alarm information or the like satisfying the sensitive condition. The second alarm information is alarm information issued from the vehicle locally, including, but not limited to, an indicator lamp sending out a warning indication, a buzzer sending out a warning buzzer, a vibration prompt device sending out a vibration prompt, etc.

It should be noted that, the processing strategy corresponding to the sensitive mode may be correspondingly set by the user when setting the sensitive mode, when the sensitive mode is set by the user independently, the processing strategy set independently can provide the user with a more personalized alarm mode, including but not limited to, sending user-defined prompt information to the user, sending a buzzer tone with a user-defined specific rhythm, the indicator lamp sending an indication in a user-defined manner, etc. When the sensitive mode is a preset sensitive mode selected by the user, intensity of an alarm mode is positively correlated with a plurality of preset sensitive modes, i.e., in the high sensitive mode, a larger number of alarm manners is enabled and the buzzer tone is relatively sharp or has a relatively long duration, an indicator lamp is constantly illuminated and has a relatively obvious color, etc.; in the medium sensitive mode, a certain number of alarm manners is enabled and prompts of the buzzer tone and the indicator lamp are normal; and in the low sensitive mode, a smaller number of alarm manners is enabled and prompts of the buzzer tone and the indicator lamp are relatively short.

In view of the above, the vehicle control method provided in the in the embodiments of the present application, in response to the sensitive mode set by the user and at least one sensitive condition corresponding to the sensitive mode, the surrounding environment of the vehicle can be recognized, and when the surrounding environment concurrently satisfies the at least one sensitive condition, the processing strategy corresponding to the sensitive mode is performed, so as to achieve a purpose of recognizing the surrounding environment corresponding to personalized setting of the user, thereby satisfying recognition requirements of the user for the surrounding environment and improving user experience.

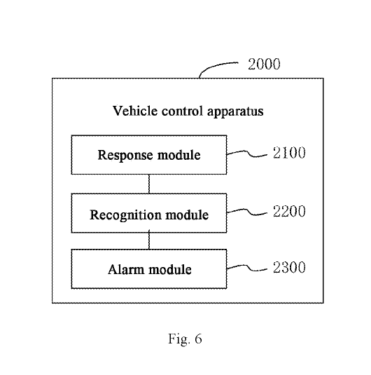

Based on the same inventive concept, FIG. 6 illustrates a schematic structural diagram of a vehicle control apparatus 2000 according to an embodiment of the present invention, the apparatus 2000 includes: a response module 2100, configured to, in response to a sensitive mode set by a user, determine at least one sensitive condition corresponding to the sensitive mode, in the embodiment of the present invention, the response module 2100 may be configured to perform step S1100 shown in FIG. 2, and the steps corresponding to step S1100 in FIG. 2 in the description herein; a recognition module 2200, configured to recognize surrounding environment of a vehicle based on the at least one sensitive condition, in the embodiment of the present invention, the recognition module 2200 may be configured to perform step S1200 shown in FIG. 2, steps S1211 to S1213 shown in FIG. 3, steps S1214 to S1215 shown in FIG. 4, steps S1221 to S1222 shown in FIG. 5 and the steps corresponding to step S1200 shown in FIG. 2, steps S1211 to S1213 shown in FIG. 3, steps S1214 to S1215 shown in FIG. 4, steps S1221 to S1222 shown in FIG. 5 in the description herein; an alarm module 2300, configured to, when determining that the surrounding environment concurrently satisfies the at least one sensitive condition and perform a processing strategy corresponding to the sensitive mode, in the embodiment of the present invention, the alarm module 2300 may be configured to perform S1300 in FIG. 2 and steps corresponding to step S1300 in the description herein.

In addition, the present application further provides a computer device. According to an embodiment of the present invention, the computer device may include a memory, a processor, and a computer program stored on the memory and executable on the processor, wherein the computer program, when executed by the processor, can implement the steps of the vehicle control method described in the description herein.

In addition, the present application further provides a computer-readable medium which may be included in the apparatus described in the above embodiments, or may also be standalone and not assembled into the apparatus. The computer-readable medium carries one or more programs which, when executed by the apparatus, cause the apparatus to perform the steps of the vehicle control method described in the description herein.

In addition, the present application further provides a computer program product including computer instructions which, when executed by a processor, may perform the steps of the vehicle control method described in the description herein.

In particular, the embodiment processes described above with reference to the flowcharts in the drawings may be implemented as a computer software program. For example, embodiments disclosed in the description of the present application include a computer program product comprising a computer program embodied on a computer-readable medium, the computer program containing program code for performing the methods illustrated in the flowcharts in the drawings, the computer program being executed by a processor to perform the methods of the present application.

It needs to be appreciated that the computer-readable medium described herein can be either a computer-readable signal medium or a computer-readable storage medium, or any combination of the two. The computer readable storage medium for example may be, but not limited to, an electronic, magnetic, optical, electromagnetic, infrared, or semiconductor system, apparatus, or device, or any combinations of the above. More specific examples of the computer-readable storage medium may include, but are not limited to: a computer diskette, a hard disk, a Random Access Memory (RAM), a Read-Only Memory (ROM), an Erasable Programmable Read-Only Memory (EPROM), a flash memory, a portable Compact Disk Read-Only Memory (CD-ROM), an optical storage device, a magnetic storage device, or any suitable combinations of the above.

In the present application, a computer readable storage medium may be any tangible medium that can contain or store a program for use by or in combination with an instruction execution system, apparatus, or device. In the present application, a computer readable signal medium may include a propagated data signal with computer readable program code embodied therein, for example, in baseband or as part of a carrier wave. Such a propagated signal may take a variety of forms, including, but not limited to, electro-magnetic, optical, or any suitable combination thereof. A computer readable signal medium may be any computer readable medium that is not a computer readable storage medium and that can send, propagate, or transmit a program for use by or in combination with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object-oriented programming languages such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the scenario involving the remote computer, the remote computer may be connected to the user’s computer through any type of network, including a local area network (LAN) or a wide area network (WAN), or the connection may be made to an external computer (for example, through the Internet using an Internet Service Provider).

The flowchart and block diagrams in the Drawings illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by dedicated hardware-based systems that perform the specified functions or acts, or combinations of dedicated hardware and computer instructions.

The units or modules involved in the embodiments of the present application may be implemented by software or hardware. The above-mentioned units or module may also be configured in a processor, and for example, may be described as: a processor including an obtaining module, a topic generation module and an execution module, etc. The names of these units or modules do not constitute limitations on the units or modules themselves in some cases.

All documents mentioned in the description are herein incorporated by reference as if each document was fully incorporated by reference herein.

In addition, it should be appreciated that those skilled in the art, upon reading through the foregoing description of the present invention, may make various alterations and modifications to the present invention, and all such equivalents are intended to fall within the scope of the present invention.

We claim:

1. A vehicle control method, comprising:
determining, in response to a sensitive mode set by a user, at least one sensitive condition corresponding to the sensitive mode;
recognizing, based on the at least one sensitive condition, a surrounding environment of a vehicle and determining that the surrounding environment concurrently satisfies the at least one sensitive condition; and
performing a processing strategy corresponding to the sensitive mode.

2. The vehicle control method according to claim 1, wherein recognizing, based on the at least one sensitive condition, the surrounding environment of the vehicle and determining that the surrounding environment concurrently satisfies the at least one sensitive condition comprises:
obtaining, for any of the at least one sensitive condition, a type of the environment information corresponding to the sensitive condition and a recognition strategy corresponding to the sensitive condition; and
obtaining information about the surrounding environment based on the type of the environment information, performing condition recognition on the information about the surrounding environment based on the recognition strategy, and determining that the surrounding environment satisfies the sensitive condition.

3. The vehicle control method according to claim 2, wherein the type of the environment information comprises image information, the recognition strategy comprises performing image recognition on the image information.

4. The vehicle control method according to claim 2, wherein the sensitive condition comprises a pedestrian category, and wherein obtaining the information about the surrounding environment based on the type of the environment information, performing the condition recognition on the information about the surrounding environment based on the recognition strategy, and determining that the surrounding environment satisfies the sensitive condition, comprises:
obtaining a pedestrian image of at least one pedestrian around the vehicle;
performing category recognition on the pedestrian based on the pedestrian image; and
determining, in response to a category of the pedestrian being a target category, that the pedestrian satisfies the sensitive condition.

5. The vehicle control method according to claim 4, wherein performing the category recognition on the pedestrian based on the pedestrian image comprises:
obtaining a target feature corresponding to the target category; and
determining whether the pedestrian image comprises the target feature, wherein in response to the pedestrian image comprising the target feature, the category of the pedestrian is determined as the target category, and in response to the pedestrian image not comprising the target feature, the category of the pedestrian is not determined as the target category.

6. The vehicle control method according to claim 5, wherein the target feature comprises a dressing feature, and wherein the method further comprises:
inputting the pedestrian image into a feature extraction model, and extracting the dressing feature of the pedestrian;
determining whether the dressing feature of the pedestrian matches the target feature corresponding to the target category; and
determining, in response to the dressing feature of the pedestrian matching the target feature corresponding to the target category, that the pedestrian is of the target category.

7. The vehicle control method according to claim 4, wherein the sensitive condition further comprises a sensitive distance, and wherein the method further comprises:
determining, in response to the category of the pedestrian being the target category, whether a distance between the pedestrian and the vehicle is less than or equal to the sensitive distance based on the pedestrian image; and
determining, in response to the distance between the pedestrian and the vehicle being less than or equal to the sensitive distance, that the pedestrian satisfies the sensitive condition.

8. The vehicle control method according to claim 7, wherein the target category and the sensitive distance have a one-to-one correspondence.

9. The vehicle control method according to claim 2, wherein the type of the environment information comprises sensing information, and the recognition strategy comprises performing data recognition on the sensing information.

10. The vehicle control method according to claim 9, wherein the sensitive condition comprises vibration information, and wherein obtaining information about the surrounding environment based on the type of the environment information, performing the condition recognition on the information about the surrounding environment based on the recognition strategy, and determining that the surrounding environment satisfies the sensitive condition, comprises:
obtaining a vibration signal generated by a vehicle body through a vibration sensor, and determining a category and an amplitude of the vibration signal; and
determining, in response to the vibration signal being a target signal and the amplitude of the vibration signal being greater than or equal to a sensitive amplitude, that the vibration signal satisfies the sensitive condition.

11. The vehicle control method according to claim 1, wherein determining, in response to the sensitive mode set by the user, the at least one sensitive condition corresponding to the sensitive mode, comprises:
determining, in response to an action of the user selecting the sensitive mode, that the user sets a corresponding sensitive mode, and determining the at least one sensitive condition corresponding to the sensitive mode.

12. The vehicle control method according to claim 1, wherein performing the processing strategy corresponding to the sensitive mode comprises:
sending first alarm information to a driver, and/or triggering local transmission of second alarm information.

13. A computer device, comprising:
a memory;
a processor; and
a computer program stored on the memory and executable on the processor, wherein the program, when executed by the processor, causes the computer device to:
determine, in response to a sensitive mode set by a user, at least one sensitive condition corresponding to the sensitive mode;
recognize, based on the at least one sensitive condition, a surrounding environment of a vehicle and determine that the surrounding environment concurrently satisfies the at least one sensitive condition; and
perform a processing strategy corresponding to the sensitive mode.

14. The computer device according to claim 13, wherein the program causing the computer device to recognize, based on the at least one sensitive condition, the surrounding environment of the vehicle and determine that the surrounding environment concurrently satisfies the at least one sensitive condition further causes the computer device to:
obtain, for any of the at least one sensitive condition, a type of the environment information corresponding to the sensitive condition and a recognition strategy corresponding to the sensitive condition; and
obtain information about the surrounding environment based on the type of the environment information, perform condition recognition on the information about the surrounding environment based on the recognition strategy, and determine that the surrounding environment satisfies the sensitive condition.

15. The computer device according to claim 14, wherein the type of the environment information comprises image information, the recognition strategy comprises performing image recognition on the image information.

16. The computer device according to claim 14, wherein the sensitive condition comprises a pedestrian category, and wherein the program causing the computer device to obtain the information about the surrounding environment based on the type of the environment information, perform the condition recognition on the information about the surrounding environment based on the recognition strategy, and determine that the surrounding environment satisfies the sensitive condition, further causes the computer device to:
obtain a pedestrian image of at least one pedestrian around the vehicle;
perform category recognition on the pedestrian based on the pedestrian image; and
determine, in response to a category of the pedestrian being a target category, that the pedestrian satisfies the sensitive condition.

17. The computer device according to claim 16, wherein the program causing the computer device to perform the category recognition on the pedestrian based on the pedestrian image further causes the computer device to:
obtain a target feature corresponding to the target category; and
determine whether the pedestrian image comprises the target feature, wherein in response to the pedestrian image comprising the target feature, the category of the pedestrian is determined as the target category, and in response to the pedestrian image not comprising the target feature, the category of the pedestrian is not determined as the target category.

18. The computer device according to claim 17, wherein the target feature comprises a dressing feature, and wherein the program further causes the computer device to:
input the pedestrian image into a feature extraction model, and extract the dressing feature of the pedestrian;
determine whether the dressing feature of the pedestrian matches the target feature corresponding to the target category; and
determine, in response to the dressing feature of the pedestrian matching the target feature corresponding to the target category, that the pedestrian is of the target category.

19. The computer device according to claim 16, wherein the sensitive condition further comprises a sensitive distance, and wherein the program further causes the computer device to:
determine, in response to the category of the pedestrian being the target category, whether a distance between the pedestrian and the vehicle is less than or equal to the sensitive distance based on the pedestrian image; and
determine, in response to the distance between the pedestrian and the vehicle being less than or equal to the sensitive distance, that the pedestrian satisfies the sensitive condition.

20. A non-transitory computer-readable storage medium having a computer program stored thereon that, when executed by a processor, causes the processor to:
determine, in response to a sensitive mode set by a user, at least one sensitive condition corresponding to the sensitive mode;
recognize, based on the at least one sensitive condition, a surrounding environment of a vehicle and determine that the surrounding environment concurrently satisfies the at least one sensitive condition; and
perform a processing strategy corresponding to the sensitive mode.
